(19) United States
(12) Patent Application Publication
(10) Pub. No.: US 2013/0098051 A1
(43) Pub. Date: Apr. 25, 2013

(54) AUXILIARY POWER UNIT BLEED CLEANING FUNCTION

(71) Applicants: Jaimer Valdez, San Diego, CA (US); Paul E. Hilgeman, Santee, CA (US)

(72) Inventors: Jaimer Valdez, San Diego, CA (US); Paul E. Hilgeman, Santee, CA (US)

(21) Appl. No.: 13/455,211

(22) Filed: Apr. 25, 2012

Related U.S. Application Data
(60) Provisional application No. 61/548,978, filed on Oct. 19, 2011.

(51) Int. Cl. F02C 6/08

(52) U.S. Cl. 60/772; 60/785

(57) ABSTRACT

An auxiliary power unit is operable to provide bleed air to a vehicle system. A method includes diverting substantially all of the bleed air to an exhaust for a selected time period commencing with startup of the auxiliary power unit. After the selected time period, at least a portion of the bleed air is diverted to the vehicle system.

### CROSS-REFERENCE TO RELATED APPLICATIONS

This application claims priority to U.S. Provisional Application No. 61/548,978, filed on Oct. 19, 2011.

### BACKGROUND

This disclosure relates to an auxiliary power unit. Aircraft, commercial vehicles, marine vehicles, aerospace vehicles and the like commonly include an auxiliary power unit for purposes other than propulsion. As examples, the auxiliary power unit may provide supplemental power to start a main engine, provide supplemental power to run electrical systems when a main engine is shut down, or provide air to a vehicle compartment.

### SUMMARY

Disclosed is a method for controlling an auxiliary power unit. The auxiliary power unit is operable to provide bleed air to a vehicle system. The method includes diverting substantially all of the bleed air to an exhaust for a selected time period commencing with startup of the auxiliary power unit. After the selected time period, at least a portion of the bleed air is diverted to the vehicle system.

In another aspect, a method for controlling an auxiliary power unit includes diverting substantially all of the bleed air to an exhaust for a selected time period commencing with a command to purge odor in an inlet duct into a compressor that provides the bleed air. After the selected time period, at least a portion of the bleed air is diverted to the vehicle system.

Also disclosed is an auxiliary power unit that includes a compressor, a bleed passage in fluid communication with the compressor to receive bleed air and a bleed control valve extending in the bleed passage. The bleed control valve includes a first state in which it is positioned to divert at least a portion of the bleed air to a vehicle system and a second state in which is positioned to divert substantially all of the bleed air to an exhaust. A controller is operable to command the bleed control valve to be in the second state for a selected time period commencing with startup of the auxiliary power unit.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example auxiliary power unit.

FIG. 2 illustrates an example method for controlling an auxiliary power unit.

### DETAILED DESCRIPTION OF THE PREFERRED EMBODIMENT

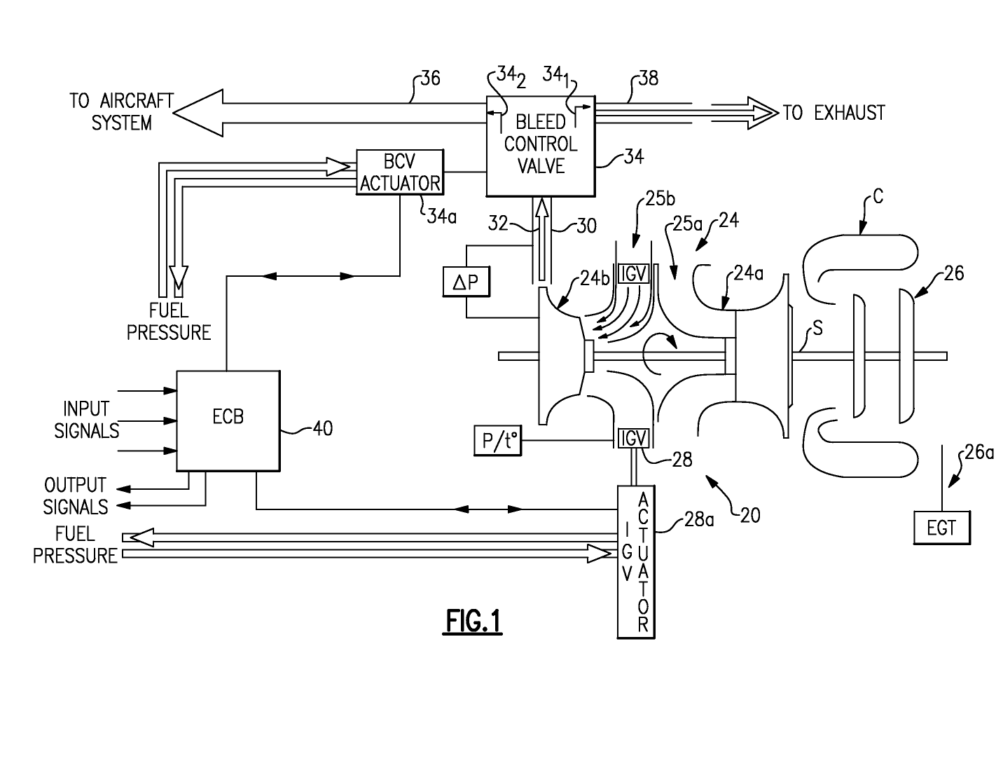

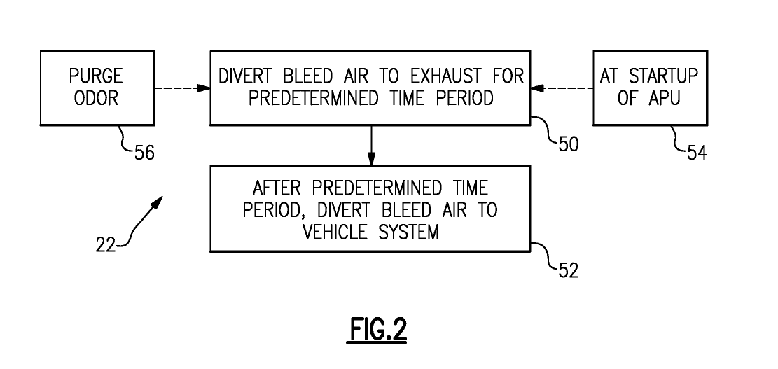

FIG. 1 shows selected portions of an example auxiliary power unit 20. As will also be described, the auxiliary power unit 20 exemplifies a method 22 (FIG. 2). An “auxiliary power unit” is understood as used herein to refer to an engine that is configured for purposes other than propulsion.

In the illustrated example, the auxiliary power unit 20 includes a compressor section 24 and a turbine section 26 that are mounted for rotation on a shaft S. The turbine section 26 is in communication with a combustor C, which produces combustion gases that are expanded in the turbine section 26 to drive the compressor section 24 in a known manner. An exhaust gas temperature probe 26a is located near the turbine section 26 for monitoring exhaust gas temperature.

In this example, the compressor section 24 includes a primary compressor 24a and a secondary compressor 24b. The primary compressor 24a and the secondary compressor 24b include respective inlets 25a and 25b for air intake. The inlet 25b of the secondary compressor 24b includes an inlet guide vane system 28 that is operable to modulate between a fully open position and closed or partially closed positions to control an amount of air intake into the secondary compressor 24b.

The auxiliary power unit 20 includes a bleed passage 30 in communication with the secondary compressor 24b for receiving bleed air 32 there from. A bleed control valve 34 extends in the bleed passage 30 and is operable to control flow of the bleed air 32 into a delivery duct 36 and an exhaust duct 38. The bleed control valve 34 has a first state 34₁ in which the bleed control valve 34 is positioned to divert at least a portion of the bleed air 32 to the delivery duct 36 and vehicle system and a second state 34₂ in which the bleed control valve 34 is positioned to divert all or substantially all of the bleed air 32 to the exhaust duct 38.

The inlet guide vane system 28 includes at least one corresponding actuator 28a, and the bleed control valve 34 includes a corresponding bleed control actuator 34a. The actuators 28a and 34a are in electrical communication with a controller 40 for controlling operation of, respectively, the inlet guide vane system 28 and the bleed control valve 34. The controller 40 is operable to command the bleed control valve 34 pursuant to the method 22 described below. In this regard, the controller may include hardware, software or both for implementing the method 22.

As shown, the controller 40 may be in communication with one or more other controllers to receive input signals and provide output signals. Additionally, the controller 40 may receive feedback from the actuators 28a and 34a and other controllers to facilitate operational control of the auxiliary power unit 20.

In operation, the compressor section 24 intakes air through the respective inlets 25a and 25b for compression in the compressors 24a and 24b. The bleed air 32 is provided through the bleed passage 30 and is selectively diverted by the bleed control valve 34 to the delivery duct 36, the exhaust duct 38 or a combination of both. In this example, the bleed air 32 that is diverted to the delivery duct 36 goes to a vehicle system, such as a vehicle compartment. In a further example, the vehicle compartment is cabin compartment. The bleed air 32 that is diverted to the exhaust duct 38 is dumped overboard to the surrounding, exterior environment of the vehicle.

The inlet 25b, or duct work that the inlet 25b is in communication with, may include one or more fluids that produce vapors within the air that is taken into the secondary compressor 24b. The fluids are not limited to any particular kind but may include hydrocarbons, for example, that are present from maintenance. Thus, especially upon startup of the auxiliary power unit 20 after vapors from the fluid may have accumulated, vapors are transported in the bleed air 32. If the bleed air 32 containing such vapors is permitted to go to the delivery duct 36 and subsequently into a cabin compartment, the vapors may cause an odor in the cabin compartment. As will be described below with reference to the method 22, the operation of the auxiliary power unit 20 can be controlled to reduce or avoid such odors.

With reference to FIG. 2, the method 22 for controlling the auxiliary power unit 20 includes step 50 of diverting the bleed air 32 to the exhaust duct 38 for a selected time period, followed by step 52 of diverting at least a portion of the bleed air 32 to the delivery duct 36 after the selected time period. By diverting the bleed air 32 to the exhaust duct 38 rather than the delivery duct 36, any vapors in the bleed air 32 that may cause an odor are not permitted to go into the vehicle or cabin compartment. Thus, the method 22 provides a “cleaning” or “purging” function for discharging vapors that may enter into the auxiliary power unit 20 through the inlet 25b.

In one example, the controller 40 causes substantially all of the bleed air 32 to be diverted to the exhaust duct 38 for a selected time period, commencing with startup of the auxiliary power unit 20, as represented at 54. That is, in response to startup of the auxiliary power unit 20, the controller 40 commands the bleed control valve 34 to be in the second state 34₂ to divert substantially all of the bleed air to the exhaust duct 38. Thus, if the bleed control valve 34 is not in the second state 34₂, it moves into the second state 34₂ and if the bleed control valve 34 is already in the second state 34₂, it remains the second state 34₂ for the selected time period. After the selected time period, the controller 40 commands the bleed control valve 34 to move to the first state 34₁ in which the bleed control valve 34 is positioned to divert at least a portion of the bleed air 32 to the delivery duct 36. Alternatively, the controller 40 may command the bleed control valve 34 to remain in the first state 34₁, but move the inlet guide vane system 28 to a different position. Such as response can be automatic with every startup or particular number of startups of the auxiliary power unit 20, or alternatively can be selected manually with startup, for example.

In another embodiment, the controller 40 commands the bleed control valve 34 to divert substantially all of the bleed air 32 into the exhaust duct 38 commencing with a command to purge odor in the inlet 25b, as represented at 56. For example, the command to purge odor may correspond with the startup of the auxiliary power unit 20 when it is known that there are vapors that may cause an odor or, alternatively, may be initiated at another time during the operation of the auxiliary power unit 20.

To facilitate operation of the auxiliary power unit 20 during the method 22, the controller 40 can also modulate the inlet guide vane system 28 during the selected time period to provide a reduced an amount of air intake with respect to a full air intake into the compressor 24b. In one example, the controller 40 modulates the inlet guide vane system 28 to 50%-75% of fully opened during the selected time period to control the amount of air intake into the compressor 24b. The modulating of the inlet guide vane system 28 to reduce or control the amount of air intake facilitates mitigation of loads on the compressor 24b. Additionally, the exhaust duct 38 is of a finite size and can only accommodate a given amount of bleed air 32. To ensure that the amount of bleed air 32 does not exceed the capacity of the exhaust duct 38, the inlet guide vane system 28 is modulated to reduce the amount of intake air. Further, the modulation of the inlet guide vane system 28 can be used to vary the value of the selected time period. For example, lower airflow may require a higher selected time period to purge the vapors to a desired degree while higher airflow may require a lower selected time period to purge the vapors to a desired degree. In one example, the selected time period may be 15 seconds but may alternatively be anywhere between a couple of seconds up to any desired time to purge the vapors to a desired degree.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method for controlling an auxiliary power unit, the method comprising:
in an auxiliary power unit that is operable to provide bleed air to a vehicle system, diverting substantially all of the bleed air to an exhaust for a selected time period commencing with startup of the auxiliary power unit; and
after the selected time period, diverting at least a portion of the bleed air to the vehicle system.

2. The method as recited in claim 1, further comprising modulating an inlet guide vane system during the selected time period to provide a reduced amount of air intake with respect to a full air intake into a compressor that provides the bleed air.

3. The method as recited in claim 1, further comprising modulating an inlet guide vane system to 50%-75% of fully open during the selected time period to control an amount of air intake into a compressor that provides the bleed air.

4. The method as recited in claim 1, including diverting substantially all of the bleed air to the exhaust in response to a command to purge odor in an inlet duct into a compressor that provides the bleed air.

5. The method as recited in claim 1, including diverting substantially all of the bleed air to the exhaust in response to startup of the auxiliary power unit.

6. A method for controlling an auxiliary power unit, the method comprising:
in an auxiliary power unit that is operable to provide bleed air to a vehicle system, diverting substantially all of the bleed air to an exhaust for a selected time period commencing with a command to purge odor in an inlet duct into a compressor that provides the bleed air; and
after the selected time period, diverting at least a portion of the bleed air to the vehicle system.

7. The method as recited in claim 6, further comprising modulating an inlet guide vane system during the selected time period to provide a reduced amount of air intake with respect to a full air intake into the compressor that provides the bleed air.

8. The method as recited in claim 6, further comprising modulating an inlet guide vane system to 50%-75% of fully open during the selected time period to control an amount of air intake into the compressor that provides the bleed air.

9. The method as recited in claim 6, wherein the command to purge odor in the inlet duct corresponds to startup of the auxiliary power unit.

10. An auxiliary power unit comprising:
a compressor;
a bleed passage in fluid communication with the compressor to receive bleed air;
a bleed control valve extending in the bleed passage, the bleed control valve including a first state in which the bleed control valve is positioned to divert at least a portion of the bleed air to a vehicle system and a second state in which the bleed control valve is positioned to divert substantially all of the bleed air to an exhaust; and
a controller operable to command the bleed control valve to be in the second state for a selected time period commencing with startup of the auxiliary power unit.

11. The auxiliary power unit as recited in claim 10, further including an inlet guide vane system arranged at an inlet into the compressor, the controller being operable to modulate the inlet guide vane system during the selected time period to provide a reduced amount of air intake with respect to a full air intake into the compressor.

12. The auxiliary power unit as recited in claim 10, further including an inlet guide vane system arranged at an inlet into the compressor, the controller being operable to modulate the inlet guide vane system to 50%-75% of fully open during the selected time period to control an amount of air intake into the compressor.

13. The auxiliary power unit as recited in claim 10, wherein the controller is operable to command the bleed control valve to be in the second state for the selected time period in response to a command to purge odor in an inlet duct into the compressor.

14. The auxiliary power unit as recited in claim 10, wherein the controller is operable to command the bleed control valve to be in the second state for the selected time period in response to startup of the auxiliary power unit.
